(19) United States
(12) Patent Application Publication
(10) Pub. No.: US 2014/0324491 A1
(43) Pub. Date: Oct. 30, 2014

(54) ASSIGNING PARTS TO STORAGE LOCATIONS IN A WAREHOUSE

(71) Applicant: International Business Machines Corporation, Armonk, NY (US)

(72) Inventors: Jon M. Banks, Austin, TX (US); James E. Varan, Austin, TX (US); Jeffrey L. Wilson, Bastrop, TX (US); Andrew P. White, Sheridan, WY (US)

(73) Assignee: International Business Machines Corporation, Armonk, NY (US)

(21) Appl. No.: 13/872,470

(22) Filed: Apr. 29, 2013

(51) Int. Cl. G06Q 10/08

(52) U.S. Cl. CPC G06Q 10/087
USPC 705/7.12

(57) ABSTRACT

Assigning parts to storage locations in a warehouse. Ratings of parts are determined based partially on pick frequencies of the parts. The parts with higher pick frequencies are determined to have higher ratings than parts with lower pick frequencies. Grades of storage locations in the warehouse are determined based partially on accessibilities of the storage locations to a loading dock. A programmed processor determines respective ranges of grades of the storage locations that will satisfy storage location criteria of the respective ratings of the parts such that the higher rated parts have narrower respective ranges of grades of satisfactory storage locations than the lower rated parts.

### FIELD OF THE INVENTION

The present invention relates generally to warehouse management, and more specifically to determining optimum storage locations in a warehouse for parts.

### BACKGROUND OF THE INVENTION

It is important to store parts in a warehouse to minimize the time and effort required to “pick” them from storage (either by forklift or by hand) and convey them to a loading dock or other pickup location. It was well known to store the most frequently needed and highest volume parts at the most convenient storage location, typically closest to the loading dock. See U.S. Pat. No. 8,407,108 to Foltz et al. which states that the most commonly used storage location strategies are popularity (the number of picks per day, or the part “velocity”), turnover (the demand of a product at any time), pick density (the ratio of the popularity to the cubic volume), cube-per-order index (the ratio of the cubic volume of parts to its turnover), where the parts with the highest number of picks should be close to the front of the picking/zones. See also, “A Heuristic Algorithm for the Warehouse Space Assignment Problem Considering Operational Constraints: with Application in a Case Study” by O. Sanei et al. in “Proceedings of the 2011 International Conference on Industrial Engineering and Operational Management.” This publication states that high volume and high movement products should be close to input and output gates of warehouse in order to minimize the total transportation while reducing logistic operations. It was also known that some storage areas and locations are more convenient for pickup for other reasons specific to the warehouse layout.

It was also known that floor level storage locations are better for pallet size pickups via forklift. See U.S. Pat. No. 8,407,108 to Foltz et al. which states that the density piece of the part volume index will provide insight into vertical storage, ensuring that bulky, dense parts are stored close to ground level. This will promote safety and decrease pick time by reducing the need for some handling equipment; stagnant parts are placed high in racks to utilize vertical space availability. U.S. Pat. No. 8,407,108 to Foltz et al. also states that the physical location of each part is determined based on the Popularity Volume Index and the required rack space for the part; pick velocity and physical dimensions are considered to recommend a warehouse location for the part. It was also known to match planned stocking quantity to the volume of the storage location.

Thus, known warehouse management systems try to store parts in an area/zone/location with a matching location accessibility rating, for example, high velocity/“A” parts are stored in highly accessible storage locations rated “A”, medium velocity/“B” parts are stored in medium accessible storage locations rated “B”, and low velocity/“C” are stored in low accessible storage locations rated “C”. After matching the velocities of the parts to the storage location accessibility ratings, known warehouse management systems try to find the best size location for the planned stocking quantity of the part given the known size of the part and historical or projected sales volumes.

An object of the present invention is to improve the matching of parts to storage locations to better utilize available storage locations.

### SUMMARY OF THE INVENTION

An embodiment of the present invention resides in a method, system and program product for assigning parts to storage locations in a warehouse. A multiplicity of ratings of a respective multiplicity of parts are determined based partially on respective pick frequencies of the parts, wherein the parts with higher pick frequencies are determined to have higher ratings than parts with lower pick frequencies. A multiplicity of grades of a respective multiplicity of storage locations in the warehouse are determined based partially on respective accessibilities of the storage locations to a loading dock or other collection point for the parts. A programmed processor determines respective ranges of grades of the storage locations that will satisfy storage location criteria of the respective multiplicity of ratings of the parts such that the higher rated parts have narrower respective ranges of grades of satisfactory storage locations than the lower rated parts.

### BRIEF DESCRIPTION OF THE FIGURES

FIG. 1 is a block diagram of a computer system to assign optimum storage locations for parts in a warehouse.

FIG. 2 is a flow chart of a storage location assignment program of the system of FIG. 1.

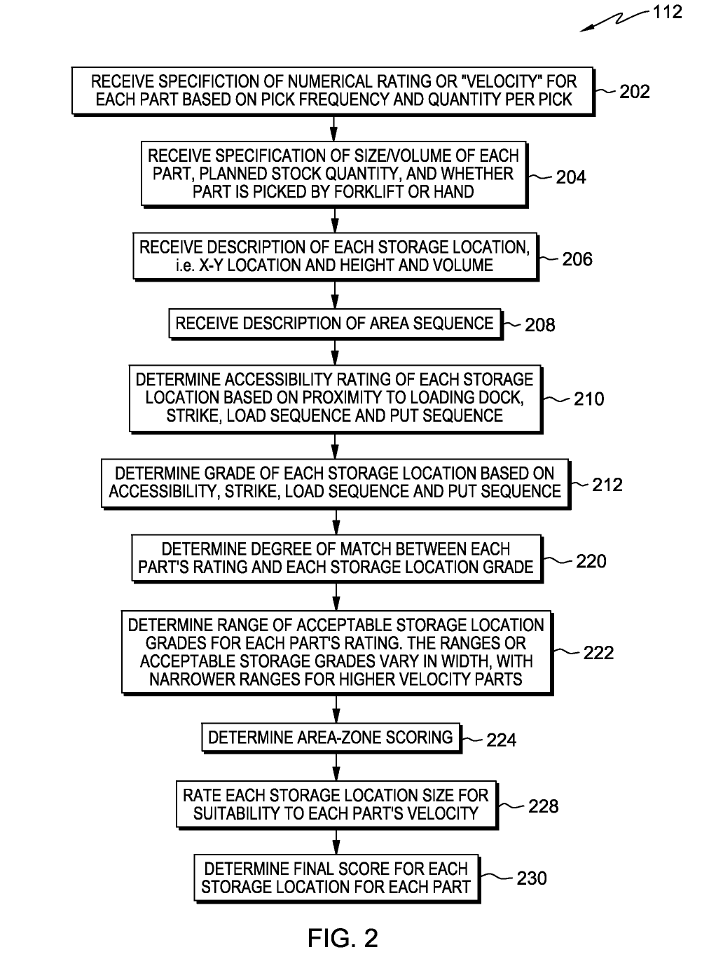

FIG. 3 is a graph of area-zone scoring.

FIG. 4 is a graph of scoring based on volume.

FIG. 5 is a block diagram of hardware and software components of the computer system of FIG. 1.

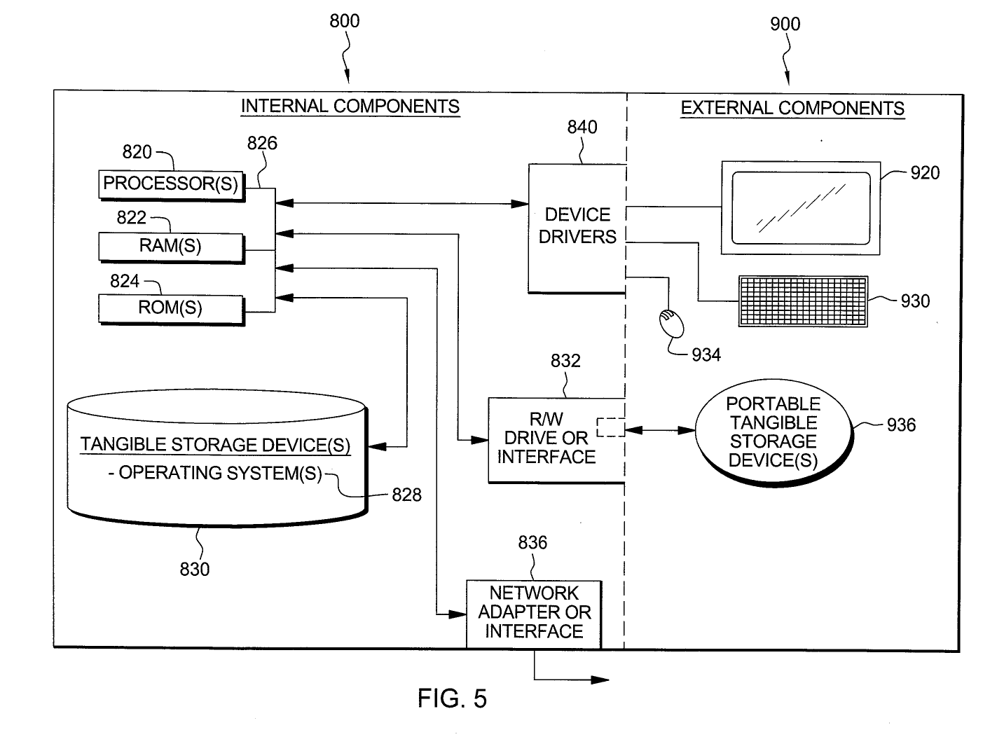

### DETAILED DESCRIPTION OF THE PREFERRED EMBODIMENTS

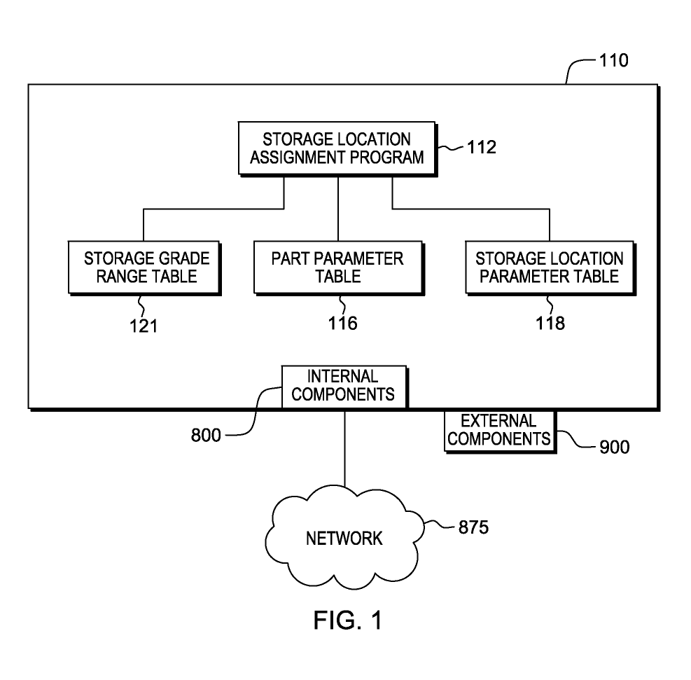

The present invention will now be described in detail with reference to the figures. FIG. 1 illustrates a computer system generally designated 110 with a storage location assignment program 112 for determining optimum locations to store respective parts in a warehouse.

During a set up phase, a warehouse manager inputs to program 112 an assigned numerical rating for each part based on historical and/or projected average frequency of picking each part and average quantity of each pick of the part, collectively called “velocity” of the part (step 202). (The average “quantity” of each pick is the average number of parts picked during each trip to the storage location.) For example, the assigned part rating is based on relative velocity of the part to the other parts. So, the part with the highest velocity is assigned a rating of 100, the part with the median velocity is assigned a rating of 50, the part with the lowest velocity is assigned a rating of 0 and parts with intermediate velocity are assigned a corresponding rating reflecting their relative position in the part velocity spectra. In the illustrated embodiment, the user-assigned part velocity range is 0-100. The part velocities are stored in part parameter table 116.

During the set up phase, the warehouse manager also inputs to program 112 the size/volume of each part, projected sales and required/planned stock quantity of the part, and whether the parts will ordinarily be picked by forklift/pallet or by hand (step 204). These and other part parameters are stored in part parameter table 116.

During the set up phase, the warehouse manager also identifies all the storage locations in the warehouse by their respective X-Y location in the horizontal plane, and their respective height above the floor, as well as their volume, and the storage area in which the storage location is contained (step 206). During the set up phase, the warehouse manager also inputs to program 112 an area sequence, i.e. primary storage area and secondary storage (step 208). Next, the warehouse manager assigns an accessibility rating to each storage location within each set of storage area and storage location size) (step 210). The location accessibility rating is based on proximity to loading dock or other shipping collection point, ease of picking (called “strike”) typically based on the height and manner of picking (either by forklift or by hand), other accessibility factor of storage area, load sequence (i.e. manner of spreading parts in the storage locations to avoid congestion of the stocking equipment), and put sequence (i.e. walking path for stock person to sequentially put parts in their assigned storage locations). For parts on a pallet picked by forklift, the floor level location is typically the most accessible (i.e. higher accessibility rating than higher levels), while for parts picked by hand, waist and torso levels are the most accessible (i.e. higher accessibility rating that very low or very high levels). In the illustrated embodiment, the storage location accessibility ratings nominally range from 0-100, but negative location grades can be assigned to identify overflow locations that are available but undesirable for use. These and other storage location parameters are stored in a storage location parameter table 118.

Next, program 112 determines a grade of each storage location based on accessibility (Acc), strike, load sequence, and put sequence (step 212). In this example, “A” represents the highest rated locations based on accessibility, “B” represents the medium rated locations based on accessibility, and “C” represents the lowest rated locations based on accessibility. In this example, the storage area has ten storage locations, each being 20″×20″×20″ in volume.

| Loc | Acc | Strike | LoadSeq | PutSeq |
|---|---|---|---|---|
| L1 | A | 1 | 1 | 1 |
| L2 | A | 2 | 2 | 2 |
| L3 | B | 5 | 3 | 3 |
| L4 | B | 1 | 4 | 4 |
| L5 | B | 2 | 5 | 5 |
| L6 | C | 1 | 6 | 6 |
| L7 | C | 2 | 7 | 7 |
| L8 | A | 5 | 8 | 8 |
| L9 | A | 5 | 9 | 9 |
| L10 | C | 5 | 10 | 10 |

The following represents the storage location grade assignment in the same example, as determined by program 112, based on the foregoing accessibility rating (Acc), strike, load sequence, and put sequence and “row”, i.e. relative grade of the storage location, in descending order, after sorting. Location Grade=100/(number of locations−1)*(row−number of locations)+100.

| Loc | Acc | Strike | LoadSeq | PutSeq | Row | Grade |
|---|---|---|---|---|---|---|
| L1 | A | 1 | 1 | 1 | 10 | 100.00 |
| L2 | A | 2 | 2 | 2 | 9 | 88.88 |
| L8 | A | 5 | 8 | 8 | 8 | 77.77 |
| L9 | A | 5 | 9 | 9 | 7 | 66.66 |
| L4 | B | 1 | 4 | 4 | 6 | 55.55 |
| L5 | B | 2 | 5 | 5 | 5 | 44.44 |
| L3 | B | 5 | 3 | 3 | 4 | 33.33 |
| L6 | C | 1 | 6 | 6 | 3 | 22.22 |
| L7 | C | 2 | 7 | 7 | 2 | 11.11 |
| L10 | C | 5 | 10 | 10 | 1 | 0.00 |

Next, the program 112 determines the degree of match of each part to each potential storage location based on how closely the part's velocity, size matches each storage location's accessibility raring and size (step 220). If the accessibility rating of a part equals the storage grade of a location then the match score=100. However, typically, there is not a perfectly matching storage location grade for each part grade. So, the program 112 determines which storage location grades are acceptable for which part velocities based on a range of acceptable storage location grades for each part velocity (step 222). Note that according to the preferred embodiment of the present invention, the size of the range of acceptable storage location grades for each part velocity is not the same for each part velocity. The more highly graded parts have the narrowest ranges of acceptable storage location grades to ensure the closest match between the high volume part velocities and the proper storage location grades, because the high volume parts represent the most traffic. Conversely, the lower velocity parts are correlated to wider storage location grade ranges to discount the importance of part velocity match to storage grade match in deference to other factors including size grade and area grade because the lower picking frequency reduces the importance of perfect storage grade match. Also, the asymmetric aspect of the location grade range width allows the discounting of location grade importance to skew toward lower storage location grades thereby retaining a higher level of part velocity concern compared to volume concern for higher graded locations. The following table defines default storage location grade ranges considered acceptable for each part velocity. In this table, the term “PartGrade” means the grade of the part, the term “RelativeRangeMin” indicates how much lower the location grade can be relative to the part grade and still be considered an acceptable storage location for the part grade. The term “RelativeRangeMax” indicates how much higher the location grade can be relative to the part grade and still be considered an acceptable storage location for the part grade.

| | | RelativeRangeMin | RelativeRangeMax |
|---|---|---|---|
| | | From Actual Part | From Actual Part |
| | PartVelocity | Velocity | Velocity |
| Range1 | 10 | −50 | +20 |
| Range2 | 20 | −40 | +20 |
| Range3 | 30 | −30 | +20 |
| Range4 | 40 | −30 | +20 |
| Range5 | 50 | −25 | +15 |
| Range6 | 60 | −25 | +15 |
| Range7 | 70 | −20 | +5 |
| Range9 | 90 | −10 | +5 |

Program 112 stores the different storage grade ranges in table 121 and displays them upon request.

Next, program 112 identifies for each part and its respective part velocity, the Range# with the closest part velocity, rounding up, to determine the magnitude of the applicable range of storage location grades for that part, applied to the actual part grade. For example, for a part with part grade=79, Range7 is closest so for this part the RelativeRangeMin=−20, and RelativeRangeMax=+5. The actual/resultant acceptable storage location range is 79−20=59 to 79+5=84, i.e., actual/resultant range of 59-84 storage location grades.

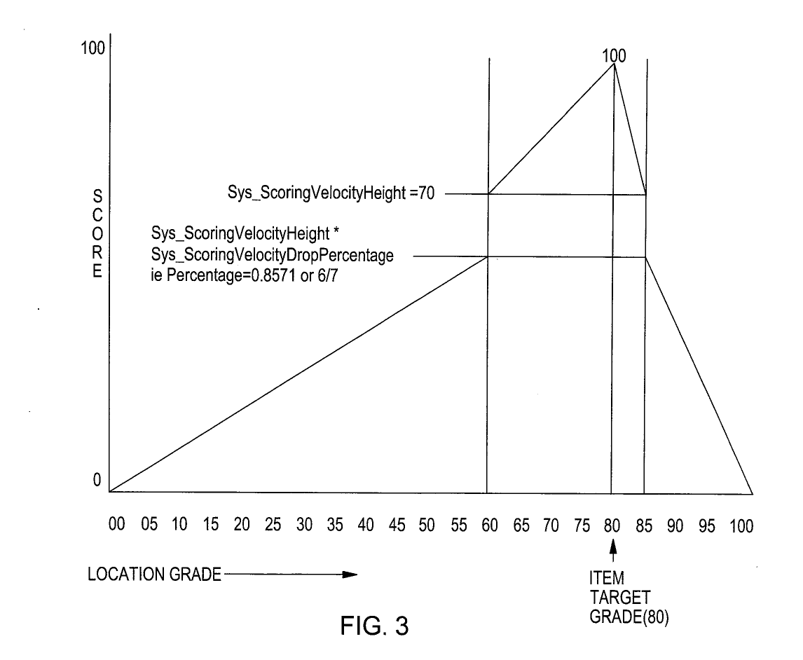

Next, as illustrated by the graph of FIG. 3, program 112 determines Area-Zone Scoring based on the part's put areas (i.e. physical division/physical area of warehouse's storage) and pick sequence (i.e. walking path to pick the parts from the storage locations) (step 224).

### Example 1

| Pick Seq. | Put Area ID | Score | Algorithm |
|---|---|---|---|
| 1 | HA | 100.0 | First Area is always scored 100 |
| 2 | HB | 90.0 | 100 − (100 − 70/ |
| | | | (total number of Areas − 1)) |
| 3 | HC | 80.0 | 100 − (area sequence − 1) * (100 − 70/ |
| | | | (total number of Areas − 1)) |
| 4 | HD | 70.0 | Last Area is always scored 70, unless |
| | | | there is only 1 Area) |

### Example 2

| Pick Seq. | Put Area ID | Score | Algorithm |
|---|---|---|---|
| 1 | HA | 100.0 | First Area is always scored 100 |
| 2 | HB | 70.0 | Last Area is always scored 50, unless |
| | | | there is only 1 Area) |

### Example 3

| Pick Seq. | Put Area ID | Score | Algorithm |
|---|---|---|---|
| 1 | HA | 100.0 | First Area is always scored 100 |

Note:
A part stored in a Put Area and not defined in that Put Area is scored 0.

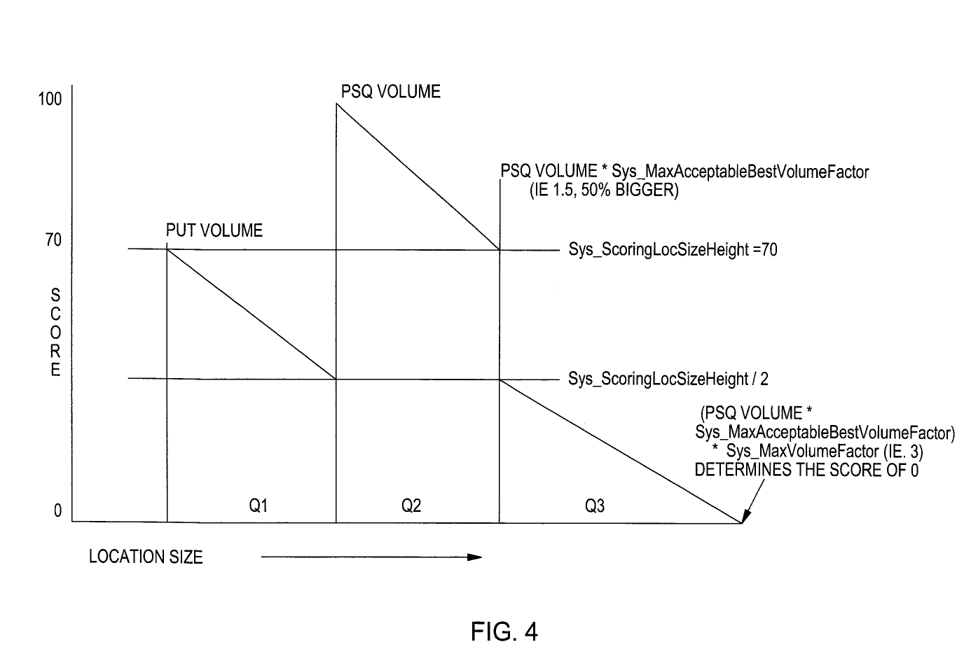

Next, program 112 considers the size of each part and the aggregate size for the requisite planned stock quantity (“PSQ”) of the part to determining the optimum storage location (after considering the part velocity in relation to the storage location grade for the part) (step 228). So, the optimum storage location of each part is based on the degree of match of the part velocity to the storage location grade as well as the size of the storage location in relation to the planned stock quantity (and its resultant volume) for the part. A storage location that can hold the PSQ is scored higher than a storage location that can only store the “put” quantity, i.e. the quantity that must be stored at the present time, for the same degree of match between the part velocity and the storage location grade. However, a storage location that cannot hold the entire PSQ but can hold the “put” quantity is scored lower than a storage location that can just hold the “put” quantity. This is done to favor ‘strategically’ sized locations that are large enough to hold the anticipated inflow of parts resulting in a long-lived home for the part minimizing the ‘risk’ of future shortfall of the part and need to relocate to a larger storage location to hold more parts. The graph of FIG. 4 illustrates the scoring based on volume where a storage location (Q2) which can hold the PSQ volume is scored higher than a storage volume which cannot (Q1), and there is a reduction in score for excess volumes above the PSQ volume and the Put volume. The graph of FIG. 4 also illustrates that storage volumes (Q3) much greater than the PSQ are rated still lower due because they waste storage space.

In the illustrated example, the System Scoring Location Size Height is 70, any score of 70 or greater is a good location size that can hold the PSQ, a score between 35-70 indicates a location that can only store put volume and not the PSQ, and a score under 35 indicates a storage location that is too big for PSQ volume. To maintain a sufficient slope for size discrimination when massively large locations exist, the location size score goes negative (<0) for a location that exceed (PSQ Volume*MaxAcceptableBestVolume)*System_Maximum Volume Factor (default value=3). (Note that in the illustrated embodiment, the Location Size Score is based on the PSQ Volume, even when the Put Volume is larger than the PSQ Volume.)

Next, program 112 determines the final score for each possible combination of part and storage location, as follows (step 230).

Given that the ‘fullness’ of the warehouse may vary, the importance of optimizing cube utilization may also vary the relative value of location grade and/or location's area fit. The algorithm considers an additional set of factors to balance the relative importance of accessibility score, location size score and area-zone score as relative weightings.

The Final Score=(part velocity/location grade match score*part velocity/location grade match weighting factor+area-zone score*area-zone weighting factor+location size score*weighting)/sum of weightings.

The weighting for the part velocity/location grade match scoring component is the relative importance of the part velocity/location grade match as specified by the warehouse manager. The weighting for the area-zone scoring component is the relative importance of the area-zone as specified by the warehouse manager. The weighting for the location size scoring component is the relative importance of the location size as specified by the warehouse manager. For example, default weightings on installation of program 112 can be 50/50/50 to reflect equal importance of each factor. But, different warehouse managers can select different weightings to emphasize one or two factors over the third. For example, a warehouse focused more heavily on picking efficiency (because of high forklift traffic in the aisles or narrow aisles) and less focused on cube utilization (because of plentiful storage space) can choose a part velocity/storage grade match weighting of 80 and a location size weighting of 40.

The final score is nominally in the range, 0-100; however, negative scores are possible to indicate an available but undesirable location or an excessively large storage location. When determining a location for a new part, potential/empty storage locations are scored as above, and program 112 uses the high scored location for the new part. Program 112 generates, displays and stores an electronic report of these final scores.

Computer system 110 includes internal components 800 and external components 900 illustrated in FIG. 3. Each of the internal components 800 includes one or more processors 820, one or more computer-readable RAMs 822 and one or more computer-readable ROMs 824 on one or more buses 826, one or more operating systems 828 and one or more computer-readable storage devices 830. The one or more operating systems 828 and program 112 are stored on one or more of the computer-readable storage devices 830 for execution by one or more of the processors 820 via one or more of the RAMs 822 (which typically include cache memory). In the illustrated embodiment, each of the computer-readable storage devices 830 is a magnetic disk storage device of an internal hard drive. Alternatively, each of the computer-readable storage devices 830 is a semiconductor storage device such as ROM 824, EPROM, flash memory or any other computer-readable storage device that can store but does not transmit a computer program and digital information.

Each of the internal components 800 also includes a R/W drive or interface 832 to read from and write to one or more portable computer-readable storage devices 936 that can store but do not transmit a computer program, such as a CD-ROM, DVD, memory stick, magnetic tape, magnetic disk, optical disk or semiconductor storage device. The program 112 can be stored on one or more of the portable computer-readable storage devices 936, read via the respective R/W drive or interface 832 and loaded into the respective hard drive or semiconductor storage device 830. The term “computer-readable storage device” does not encompass signal propagation media such as copper cables, optical fibers and wireless transmission media.

Each of the internal components 800a,b,c also includes a network adapter or interface 836 such as a TCP/IP adapter card or wireless communication adapter (such as a 4G wireless communication adapter using OFDMA technology). The program 112 can be downloaded to the computer system 110 from an external computer or external storage device via a network 875 (for example, the Internet, a local area network or other, wide area network or wireless network) and network adapter or interface 836. From the network adapter or interface 836, the programs are loaded into the hard drive or semiconductor storage device 830. The network may comprise copper wires, optical fibers, wireless transmission, routers, firewalls, switches, gateway computers and/or edge servers.

Each of the external components 900a,b,c includes a display screen 920, a keyboard or keypad 930, and a computer mouse or touchpad 940. Each of the internal components 800a,b,c also includes device drivers 840 to interface to display screen 920 for imaging, to keyboard or keypad 930, to computer mouse or touchpad 934, and/or to display screen for pressure sensing of alphanumeric character entry and user selections. The device drivers 840, R/W drive or interface 832 and network adapter or interface 836 comprise hardware and software (stored in storage device 830 and/or ROM 824).

The programs can be written in various programming languages (such as Java, C+) including low-level, high-level, object-oriented or non object-oriented languages. Alternatively, the functions of the programs can be implemented in whole or in part by computer circuits and other hardware (not shown).

Based on the foregoing, a computer system, method and program product have been disclosed for optimizing storage locations for parts in a warehouse. However, numerous modifications and substitutions can be made without deviating from the scope of the present invention. Therefore, the present invention has been disclosed by way of example and not limitation.

1. A method for assigning parts to storage locations in a warehouse, the method comprising the steps of:
determining a multiplicity of ratings of a respective multiplicity of parts based partially on respective pick frequencies of the parts, wherein the parts with higher pick frequencies are determined to have higher ratings than parts with lower pick frequencies;
determining a multiplicity of grades of a respective multiplicity of storage locations in the warehouse based partially on respective accessibilities of the storage locations to a loading dock or other collection point for the parts; and
determining, by one or more processors, respective ranges of grades of the storage locations that will satisfy storage location criteria of the respective multiplicity of ratings of the parts such that the higher rated parts have narrower respective ranges of grades of satisfactory storage locations than the lower rated parts.

2. The method of claim 1 wherein the accessibility of the storage locations to a loading dock or other collection point is based partially on respective proximities of the storage locations to the loading dock or the other collection point and respective heights of the storage locations relative to a floor of the warehouse.

3. A computer program product for assigning parts to storage locations in a warehouse, the computer program product comprising:
one or more computer-readable storage devices and program instructions stored on at least one of the one or more storage devices, the program instructions comprising:
program instructions to receive specification of a multiplicity of ratings of a respective multiplicity of parts based partially on respective pick frequencies of the parts, wherein the parts with higher pick frequencies are determined to have higher ratings than the parts with lower pick frequencies;
program instructions to receive specification of a multiplicity of grades of a respective multiplicity of storage locations in the warehouse based partially on respective accessibilities of the storage locations to a loading dock or other collection point for the parts; and
program instructions to determine respective ranges of grades of the storage locations that will satisfy storage location criteria of the respective multiplicity of ratings of the parts such that the higher rated parts have narrower respective ranges of grades of satisfactory storage locations than the lower rated parts.

4. The computer program product of claim 3, wherein the accessibility of the storage locations to a loading dock or other collection point is based partially on respective proximities of the storage locations to the loading dock or the other collection point and respective heights of the storage locations relative to a floor of the warehouse.

5. A computer system for assigning parts to storage locations in a warehouse, the computer system comprising:
one or more processors, one or more computer-readable memories, one or more computer-readable storage devices, and program instructions stored on at least one of the one or more storage devices for execution by at least one of the one or more processors via at least one of the one or more memories, the program instructions comprising:
program instructions to receive specification of a multiplicity of ratings of a respective multiplicity of parts based partially on respective pick frequencies of the parts, wherein the parts with higher pick frequencies are determined to have higher ratings than the parts with lower pick frequencies;
program instructions to receive specification of a multiplicity of grades of a respective multiplicity of storage locations in the warehouse based partially on respective accessibilities of the storage locations to a loading dock or other collection point for the parts; and
program instructions to determine respective ranges of grades of the storage locations that will satisfy storage location criteria of the respective multiplicity of ratings of the parts such that the higher rated parts have narrower respective ranges of grades of satisfactory storage locations than the lower rated parts.

6. The computer system of claim 5, wherein the accessibility of the storage locations to a loading dock or other collection point is based partially on respective proximities of the storage locations to the loading dock or the other collection point and respective heights of the storage locations relative to a floor of the warehouse.
